(19) United States
(12) Patent Application Publication
(10) Pub. No.: US 2017/0241382 A1
(43) Pub. Date: Aug. 24, 2017

(54) Engine Having High Capacity Induction Path

(71) Applicant: Joseph Facciano, Burbank, CA (US)

(72) Inventor: Joseph Facciano, Burbank, CA (US)

(21) Appl. No.: 15/049,715

(22) Filed: Feb. 22, 2016

(51) Int. Cl. F02M 35/10

(52) U.S. Cl. CPC F02M 35/10118; F02M 35/10144

(57) ABSTRACT

An internal combustion engine having poppet valves is disclosed, wherein induction ports serving intake valves are siamesed. Induction ports have proximal portions about parallel to the valve stem axis of their associated intake valves, and distal portions roughly parallel to the engine block deck surface. The proximal portions flare to greater width with increasing proximity to valve heads. The distal portions are smaller in cross section than the proximal portions. The combustion chamber includes a bulge projecting away from the piston crown, providing additional space for induction air flow.

### FIELD OF THE DISCLOSURE

The present disclosure relates to internal combustion engines, and more particularly, to a breathing arrangement for improving volumetric efficiency in poppet valve engines.

### BACKGROUND

Many different valve and manifolding designs have been proposed for internal combustion engines. One goal that has remained consistent is that of maximizing volumetric efficiency. In naturally aspirated engines, it has been proposed to provide four or even five valves for each cylinder. Manifolds have been proposed to increase induction air flow. Cylinder configurations and valve orientations have been proposed to maximize induction volume. There remains room in the art of internal combustion engines for further improvement in volumetric efficiency.

### SUMMARY

The disclosed concepts address the above stated situation by providing a valve port configuration which, taken together with certain valve area ratios of exhaust valves and intake valves, produces improved volumetric efficiency. A single induction ports serves two adjacent intake valves. The ratio of the area of an exhaust valve to the area of an intake valve is approximately 0.65.

Additionally, the port is configured to eliminate the usual sharp angle of approach of induction air flow at the valve. Whereas many conventional port designs have a nearly right angled turn proximate the intake valve, in the present disclosure, the angle of approach is far more gradual, so that direction of induction air flow approaches parallel to the axis of the valve stem.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a nested block diagram of components of an engine, according to at least one aspect of the disclosure;

FIG. 2 is a diagrammatic top plan view of a representative pair of cylinders of the engine of FIG. 1, according to at least one aspect of the disclosure;

FIG. 3 is a diagrammatic side view of the cylinder head of FIG. 2, shown partly in cross section, according to at least one aspect of the disclosure;

FIG. 4 is a side view of the cylinder head of FIG. 2, taken along line 4-4 in FIG. 2, and shown partly in cross section, according to at least one aspect of the disclosure;

FIG. 5 is a diagrammatic top view of a representative pair of cylinders of the engine of FIG. 1, according to at least on additional aspect of the invention.

### DETAILED DESCRIPTION

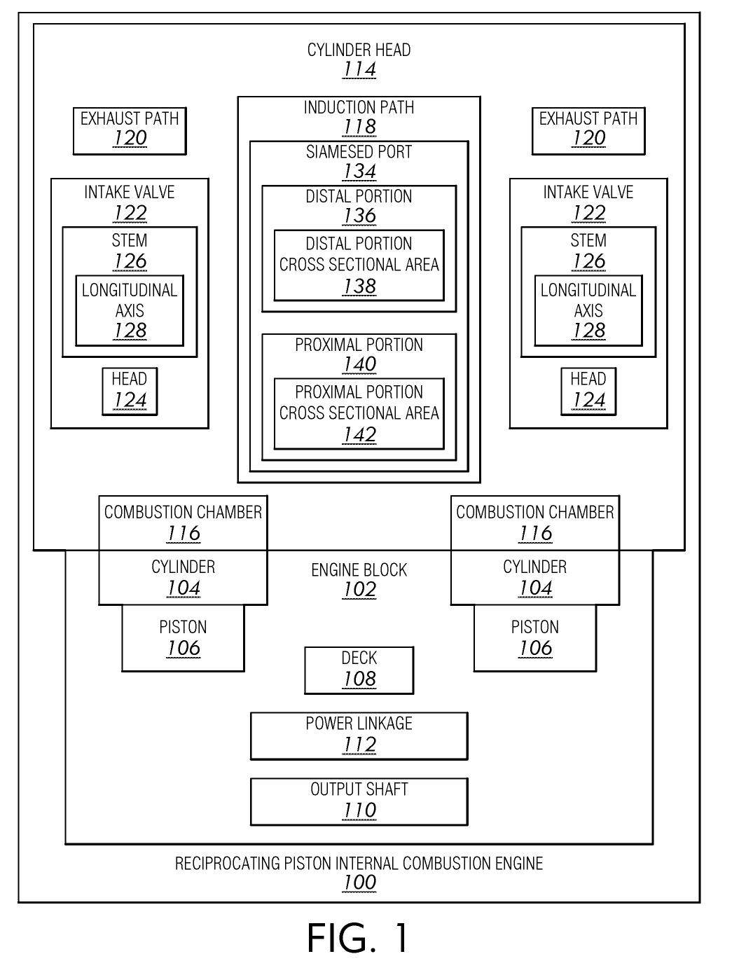

Referring first to FIG. 1, according to at least one aspect of the disclosure, there is shown a reciprocating piston internal combustion engine 100, comprising an engine block 102 supporting at least one cylinder 104 enclosing a piston 106 slidably and reciprocably disposed within cylinder 104. Engine block 102 has at least one deck 108. Reciprocating piston internal combustion engine 100 also includes an output shaft 110 supported by engine block 102, a power linkage 112 which operably conducts power developed by reciprocation of piston 106 within its associated cylinder 104 to output shaft 110. Reciprocating piston internal combustion engine 100 further includes a cylinder head 114 defining therein a combustion chamber 116 for each cylinder 104, an induction path 118 disposed to conduct fresh combustion air to each cylinder 104, and an exhaust path 120 disposed to conduct spent combustion products away from each cylinder 104. Cylinder head 114 closes one end of cylinder 104. Cylinder 104 abuts engine block 102 at deck 108.

For each cylinder 104, there is an intake valve 122 in induction path 118, intake valve 122 disposed to open and close induction path 118 to flow of fresh combustion air to each cylinder 104. Intake valve 122 has an intake valve head 124 and a stem 126 having a stem longitudinal axis 126. For each cylinder 104, there is an exhaust valve 130 disposed in exhaust path 120 to open and close combustion chamber 116 to exhaust path 120. Exhaust valve 130 has an exhaust valve head 132.

Induction path 118 includes a siamesed port 134 for pairs of adjacent cylinders 104, wherein siamesed port 134 has a distal portion 136 having a distal portion cross sectional area 138 and a proximal portion 140 having a proximal portion cross sectional area 142 greater than distal portion cross sectional area 138.

A siamesed port is a passage which splits or branches from a single passage to two passages, to serve two adjacent intake valves 122.

Some components of reciprocating piston internal combustion engine 100 have been omitted from FIG. 1.

Apart from siamesed port 134 of induction path 118, components of reciprocating piston internal combustion engine 100 are well known. Deck 108 is a surface ordinarily oriented upwardly when engine block 102 is installed in a motor vehicle (not shown). There may be more than one deck 108. For example, “V” configured engines such as V4, V6, V8, V10, and V12 engines (none of these is shown) have two decks 108. Single cylinder engines and in-line two-, three-, and four-cylinder engines (none shown) have one deck 108.

Output shaft 110 may be a crankshaft for example. Power linkage 112 may comprise a connecting rod (not shown), a yoke (not shown), or other mechanical component coupling each piston 106 to output shaft 110.

Depending upon context, combustion chamber 116 will be understood to refer to an open volume above each associated piston 106, or to refer to that open volume and a wall of cylinder head 114 bounding the open volume.

Induction path 118 will be understood to encompass passages within cylinder head 114, and in a complete engine, passages including those in intake manifold(s) where provided, and ancillary components such as throttle body where provided, air mass flow sensor, and air filter. Exhaust path 120 will be understood to encompass passages within cylinder head 114, and in a complete engine, passages in exhaust manifold(s) where provided. Complete engines will be understood to include supporting systems such as fuel supply systems, cooling systems, lubrication systems, ignition systems, starting systems, electrical charging systems, engine operation sensors, throttles, superchargers including turbochargers where provided, power brake pumps where provided, air pumps for post cylinder combustion air, power steering pumps, and pulleys, brackets, and other components for other vehicular systems such as air conditioning systems, emission control systems, and other known systems. The supporting systems described above are well known and need not be further detailed herein.

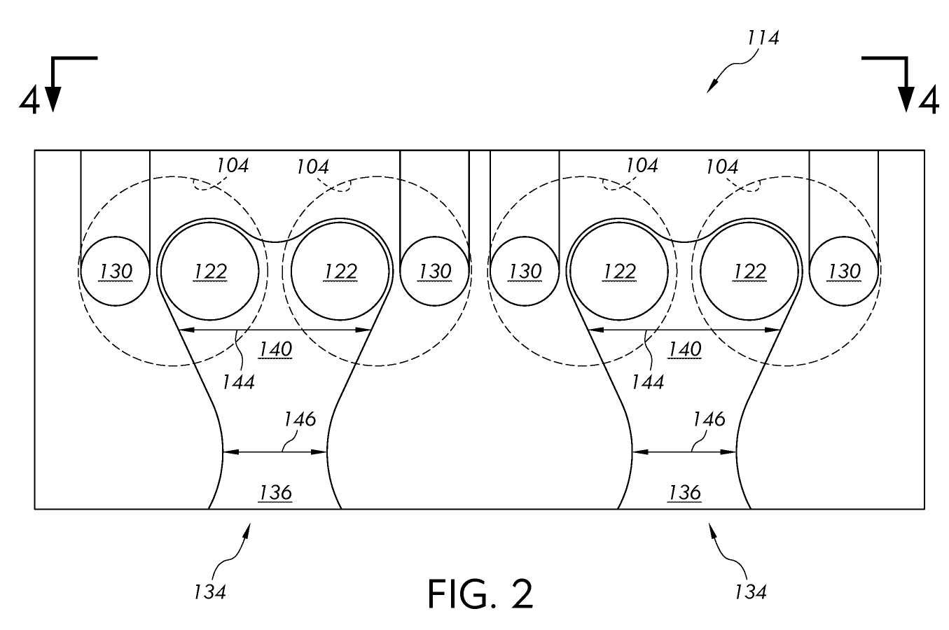

Referring also to FIG. 2, in reciprocating piston internal combustion engine 100, when considered in plan view, proximal portion 140 increases in width 144 with greater proximity to intake valves 122 associated with siamesed port 134. Width 144 is greater in magnitude than width 146 of distal portion 136 of siamesed port 134.

FIG. 2 shows cylinder head details for a bank of four cylinders.

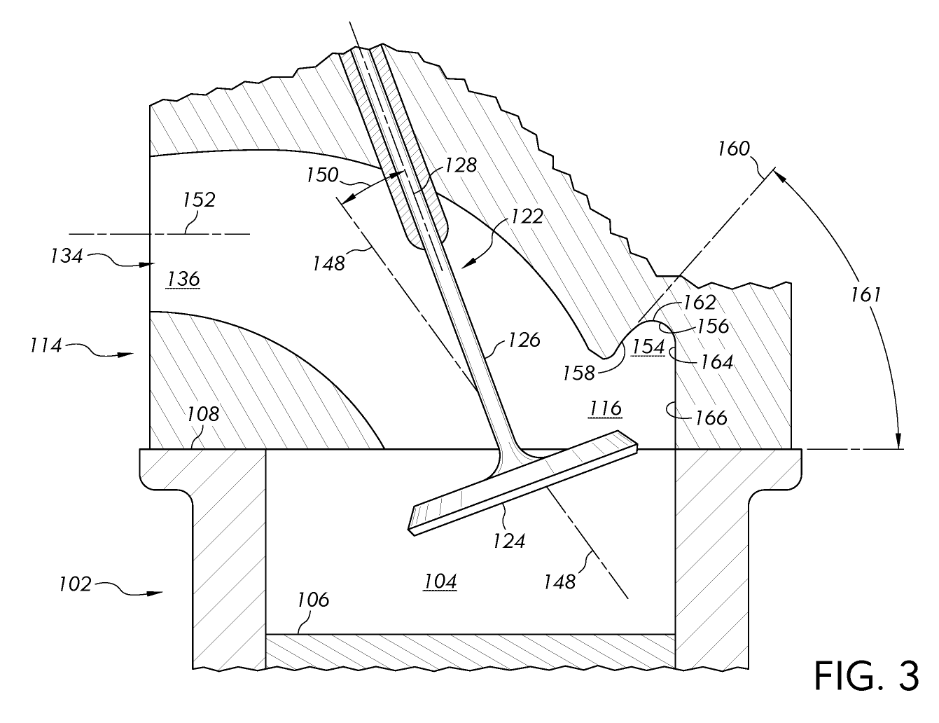

Referring additionally to FIG. 3, which shows cylinder and cylinder head details for a single cylinder 104, in reciprocating piston internal combustion engine 100, proximal portion 140 of siamesed port 134 is inclined relative to deck 108 of engine block 102 such that air flow proximate each intake valve head 124 is generally parallel to stem longitudinal axis 128 of each intake valve 124. Direction of air flow proximate intake valve head 124 is indicated by an axis 148 approximating the geometric center line of proximal portion 140 of siamesed port 134. Recognizing that contours of siamesed port 134 vary, “generally parallel” will be understood to deviate from parallel by up to twenty-five degrees from stem longitudinal axis 128. This angle is indicated by an arrow 150.

FIG. 3 also shows that in reciprocating piston internal combustion engine 100, distal portion 136 of siamesed port 134 has a central axis 152 generally parallel to deck 108 associated with siamesed port 134.

In reciprocating piston internal combustion engine 100, proximal portion 140 of siamesed port 134 has a central axis 148 at deck 108 intersecting central axis 152 of distal portion 136 of siamesed port 134 at an angle in a range of forty-five to sixty degrees. The angle of central axis 148 is taken where central axis 148 passes from cylinder head 114 through deck 108 of engine block 102. Central axis 152 is extended to the right in FIG. 3 to the point of intersection with central axis 148 to generate the angle in the range of forty-five to sixty degrees. This geometry provides a gradual, curved transition from horizontal flow to almost vertical flow in siamesed port 134. By contrast with this gradual transition, many conventional engines have intake ports making a nearly perpendicular turn at the valve head, which may introduce unwanted fluid eddy currents and other disruptions to orderly air flow.

In reciprocating piston internal combustion 100, each intake valve 122 has an intake valve area, each exhaust valve 130 has an exhaust valve area, and a ratio of the exhaust valve area to the intake valve area is in a range from 0.45 to 0.7. The area of the respective valves 122, 130 is based on diameters of heads 124, 132 of the valves 122, 130. In a currently preferred embodiment, the ration of the exhaust valve area to the intake valve area is about 0.65.

Referring again to FIG. 3, in reciprocating piston internal combustion engine 100, combustion chamber 116 comprises a bulge 154 in combustion chamber 116. Bulge 154 projects away from piston 106 and opens towards piston 106. Bulge 154 has a distal portion 156 located further from piston 106 than any part of head 124 of intake valve 122 is located from piston 106. Bulge 154 has a wall portion 158 located proximate head 124 of intake valve 122 which has a slope 160 arranged at an acute angle 161 to deck 108 of engine block 102. Bulge 154 provides more space for flow of induction air than would occur in the absence of bulge 154.

In reciprocating piston internal combustion engine 100, bulge 154 has a rounded domed configuration at that point 162 farthest from piston 106. That wall 164 of bulge 154 located farthest from intake valve 122 makes a continuous transition towards coincidence with combustion chamber wall 166. Alternatively stated, wall 164 makes a gradual, curved transition from point 162 to vertical combustion chamber wall 166.

It should be noted at this point that orientational terms such as vertical refer to the subject drawing as viewed by an observer. The drawing figures depict their subject matter in orientations of normal use, which could obviously change with changes in engine design, engine mounting, and the like. Therefore, orientational terms must be understood to provide semantic basis for purposes of description only, and do not imply that their subject matter can be used only in one position.

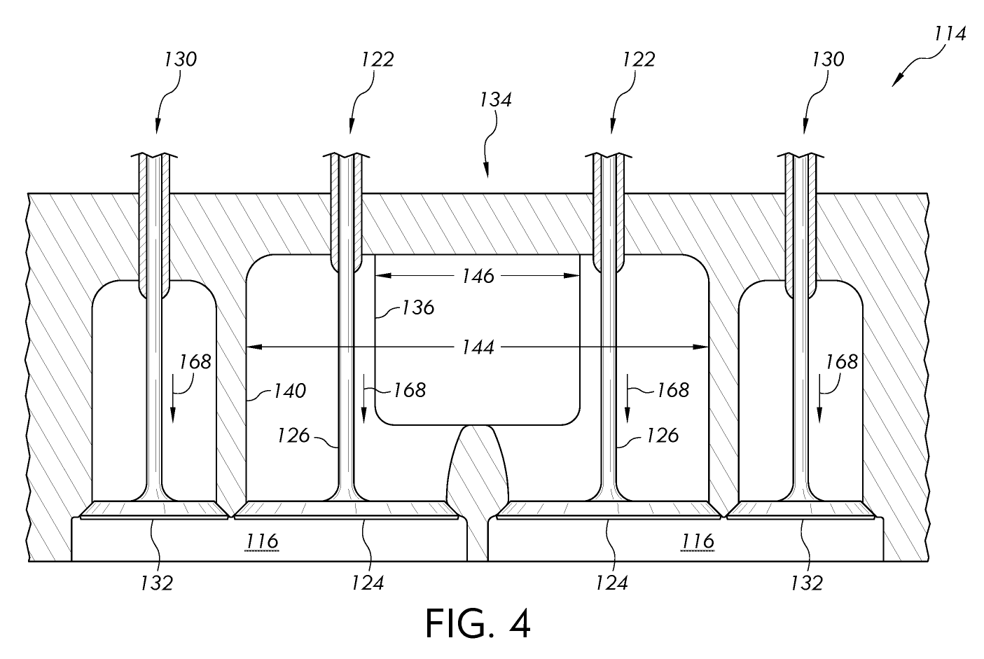

Referring also to FIG. 4, which shows details of a cylinder head and cylinders of a pair of cylinders 104, in reciprocating piston internal combustion engine 100, within each cylinder 104, each one of intake valves 122 has an axis of travel and each one of exhaust valves 130 has an axis of travel parallel to that of one of intake valves 122. Direction of travel of valves 122, 130 is indicated by an arrow 168. The actual axis of travel is the same in intake valves 122 as stem longitudinal axis 128 (see FIG. 3). Exhaust valves 130 have similar axes.

FIG. 4 also shows relative widths 144, 146 of proximal portion 142 and distal portion 136.

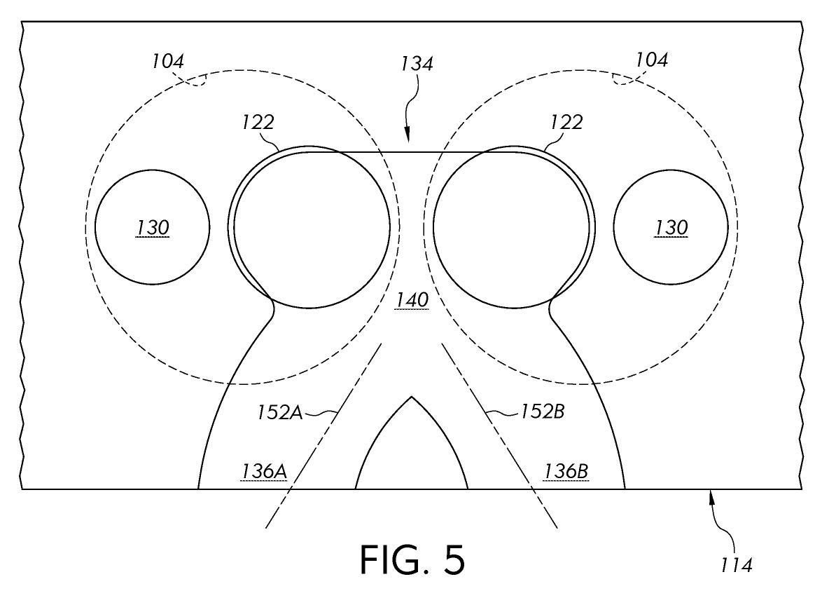

FIG. 5 shows a portion of reciprocating piston internal combustion engine 100, wherein siamesed port 134 includes, for each pair of cylinders 104, a first distal portion 136A having a first central axis 152A and a second distal portion 136B having a second central axis 152B intersecting first central axis 152A when viewed in an azimuth view. The view of FIG. 5 is an azimuth view because first and second distal portions 136A and 136B, and their respective first and second central axes 152A, 152B could be curved. If present, this curvature would not be seen in the azimuth view of FIG. 5. Hence even if there were a slight offset of first and second distal portions 136A, 136B from deck 108 (see FIG. 3) and consequent misalignment of first and second central axes 152A, 152B (misalignment is not shown), there would still be apparent intersection of first and second central axis 152A, 152B in the azimuth view. This geometry promotes straighter flow of induction air towards each opening associated with each intake valve 122, with less choking effect and consequently, greater mass of air entering each cylinder 104 during each intake stroke.

Other than the above described geometry of first and second distal portions 136A, 136B, geometric features described herein afford greater cross sectional area for induction breathing than occurs in other engine designs. Large intake valve area is provided to exploit the greater induction breathing cross sectional area.

In the above description, numerous specific details are set forth in order to provide an understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A reciprocating piston internal combustion engine, comprising:
an engine block supporting at least one cylinder enclosing a piston slidably and reciprocably disposed within the cylinder, the engine block having at least one deck;
an output shaft supported by the engine block;
a power linkage which operably conducts power developed by reciprocation of the piston within its associated cylinder to the output shaft; and
a cylinder head defining therein a combustion chamber for each cylinder, an induction path disposed to conduct fresh combustion air to each cylinder, and an exhaust path disposed to conduct spent combustion products away from each cylinder, wherein the combustion chamber closes one end of the cylinder, wherein the cylinder abuts the engine block at the deck;
for each cylinder, an intake valve in the induction path, the intake valve disposed to open and close the induction path to flow of fresh combustion air to each cylinder, and having an intake valve head and a stem having a stem longitudinal axis;
for each cylinder, an exhaust valve disposed in the exhaust path to open and close the combustion chamber to the exhaust path, and having an exhaust valve head, and wherein
the induction path includes a siamesed port for pairs of adjacent cylinders wherein the siamesed port has a distal portion having a distal portion cross sectional area and a proximal portion having a proximal portion cross sectional area greater than the distal portion cross sectional area.

2. The reciprocating piston internal combustion engine of claim 1, wherein, when considered in plan view, the proximal portion increases in width with greater proximity to the intake valves associated with the siamesed port.

3. The reciprocating piston internal combustion engine of claim 1, wherein the proximal portion of the siamesed port is inclined relative to the deck of the engine block such that air flow proximate each intake valve head is generally parallel to the stem longitudinal axis of each said intake valve.

4. The reciprocating piston internal combustion engine of claim 3, wherein the distal portion of the siamesed port has a central axis generally parallel to the deck associated with the siamesed port.

5. The reciprocating piston internal combustion engine of claim 4, wherein the proximal portion of the siamesed port has a central axis at the deck intersecting the central axis of the distal portion of the siamesed port at an angle in a range of forty-five to sixty degrees.

6. The reciprocating piston internal combustion engine of claim 1, wherein each said intake valve has an intake valve area, each said exhaust valve has an exhaust valve area, and a ratio of the exhaust valve area to the intake valve area is in a range from 0.45 to 0.7.

7. The reciprocating piston internal combustion engine of claim 6, wherein the ration of the exhaust valve area to the intake valve area is about 0.65.

8. The reciprocating piston internal combustion engine of claim 1, wherein
the combustion chamber comprises a bulge in the combustion chamber, which said bulge projects away from the piston and opens towards the piston, wherein the bulge has a distal portion located further from the piston than any part of the head of the intake valve is located from the piston, and wherein the bulge has a wall portion located proximate the head of the intake valve which has a slope arranged at an acute angle to the deck of the engine block.

9. The reciprocating piston internal combustion engine of claim 8, wherein the bulge has a rounded domed configuration at that point farthest from the piston, and further wherein that wall of the bulge located farthest from the intake valve makes a continuous transition towards coincidence with the cylinder wall.

10. The reciprocating piston internal combustion engine of claim 1, wherein within each cylinder, each one of the intake valves has an axis of travel and each one of the exhaust valves has an axis of travel parallel to that of one of the intake valves.

11. The reciprocating piston internal combustion engine of claim 1, wherein the siamesed port includes, for each pair of cylinders, a first distal portion having a first central axis and a second distal portion having a second central axis intersecting the first central axis when viewed in an azimuth view.
